(19) United States
(12) Patent Application Publication
(10) Pub. No.: US 2019/0102674 A1
(43) Pub. Date: Apr. 4, 2019

(54) METHOD, APPARATUS, AND SYSTEM FOR SELECTING TRAINING OBSERVATIONS FOR MACHINE LEARNING MODELS

(71) Applicant: HERE GLOBAL B.V., Eindhoven (NL)

(72) Inventors: Richard KWANT, Oakland, CA (US); Anish MITTAL, Berkeley, CA (US); David LAWLOR, Chicago, IL (US)

(21) Appl. No.: 15/721,002

(22) Filed: Sep. 29, 2017

(51) Int. Cl. G06N 3/08; G06F 17/30; G06N 99/00

(52) U.S. Cl. CPC G06N 3/08; G06F 17/30303; G06F 17/30705; G06F 17/30011; G06N 99/005

(57) ABSTRACT

An approach is provided for selecting training observations for machine learning models. The approach involves determining a first distribution of a plurality of features observed in the training data set, and a second distribution of the plurality of features observed in the candidate pool of observations. The approach further involves selecting one or more observations in the candidate pool of observations for annotation based on the first distribution and the second distribution. The approach further involves adding the one or more observations to the training data set after annotation. The training data set is used for training the machine learning model.

### BACKGROUND

Over the past decades, massive increases in the scale and type of annotated data have accelerated advances in all areas of machine learning. This has enabled major advances is many areas of science and technology, as complex models of physical phenomena or user behavior, with millions or perhaps billions of parameters, can be fit to data sets of increasing size. The process of annotating observations to train machine learning models is often the most time-consuming and expensive part of the machine learning pipeline, as it requires human input for each observation, which can number in the hundreds of thousands to millions. Accordingly, service providers face significant technical challenges to enable efficient automated means for determining which observations are to be annotated and included in training data sets for machine learning.

### SOME EXAMPLE EMBODIMENTS

Therefore, there is a need for an approach for selecting representative training observations for annotation in machine learning.

According to one embodiment, a computer-implemented method for sampling from a candidate pool of observations to create a training data set for a machine learning model comprises determining, by a processor, a first distribution of a plurality of features observed in the training data set. The method also comprises determining a second distribution of the plurality of features observed in the candidate pool of observations. The method further comprises selecting one or more observations in the candidate pool of observations for annotation based on the first distribution and the second distribution. The method further comprises adding the one or more observations to the training data set after annotation. The training data set is used for training the machine learning model.

According to another embodiment, an apparatus for sampling from a candidate pool of observations to create a training data set for a machine learning model comprises at least one processor, and at least one memory including computer program code for one or more computer programs, the at least one memory and the computer program code configured to, with the at least one processor, cause, at least in part, the apparatus to determine a first distribution of a plurality of features observed in the training data set. The apparatus is also caused to determine a second distribution of the plurality of features observed in the candidate pool of observations. The apparatus is further caused to select one or more observations in the candidate pool of observations for annotation based on the first distribution and the second distribution. The apparatus is further caused to add the one or more observations to the training data set after annotation. The training data set is used for training the machine learning model.

According to another embodiment, a non-transitory computer-readable storage medium for sampling from a candidate pool of observations to create a training data set for a machine learning model carries one or more sequences of one or more instructions which, when executed by one or more processors, cause, at least in part, an apparatus to determine a first distribution of a plurality of features observed in the training data set. The apparatus is also caused to determine a second distribution of the plurality of features observed in the candidate pool of observations. The apparatus is further caused to select one or more observations in the candidate pool of observations for annotation based on the first distribution and the second distribution. The apparatus is further caused to add the one or more observations to the training data set after annotation. The training data set is used for training the machine learning model.

According to another embodiment, an apparatus for sampling from a candidate pool of observations to create a training data set for a machine learning model comprises means for determining, by a processor, a first distribution of a plurality of features observed in the training data set. The apparatus also comprises means for determining a second distribution of the plurality of features observed in the candidate pool of observations. The apparatus further comprises means for selecting one or more observations in the candidate pool of observations for annotation based on the first distribution and the second distribution. The apparatus further comprises means for adding the one or more observations to the training data set after annotation. The training data set is used for training the machine learning model.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of selecting training observations for machine learning models, according to one embodiment;

FIG. 2 is a flowchart of a process for selecting training observations for machine learning models, according to one embodiment;

FIG. 3 is an example distribution in a feature space used for selecting training observations, according to one embodiment;

FIG. 4 is a diagram illustrating an example use of case of selecting training images training a machine learning model, according to one embodiment;

FIGS. 5A-5C are diagrams illustrating the distributions of training, candidate, and sampled observations through iterations of the observation selection procedure, according to various embodiments;

FIG. 6 is a diagram of a geographic database, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for selecting training observations for annotation and use in training a machine learning model are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

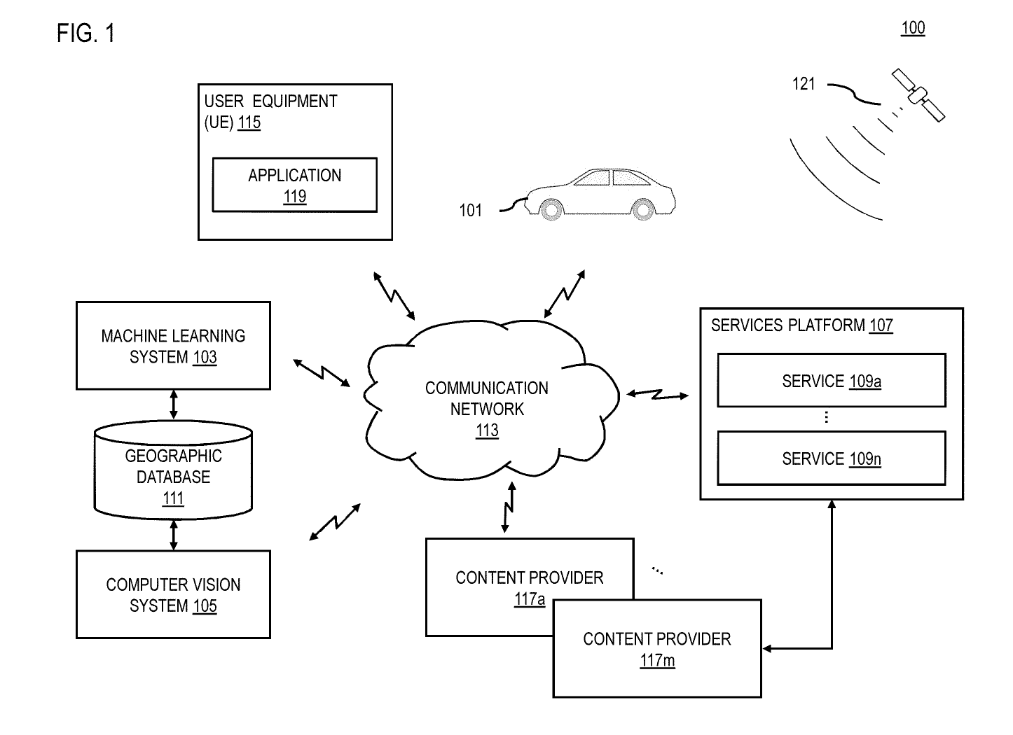

FIG. 1 is a diagram of a system capable of selecting training observations for machine learning models, according to one embodiment. As noted above, training a machine learning model generally requires a large set of annotated observations. In one embodiment, annotated observations can be data records or files representing or recording observations of a phenomenon that have been manually labeled with features or characteristics identified by an observer. For example, with training a machine learning model to detect objects or features depicted in images, an annotated observation can be an image that has been labeled with the objects or features as identified by a human labeler as being depicted in the corresponding image. However, a large number of such labeled observations is often not sufficient to train an effective machine learning model. Just as important is the diversity of observations seen by the model during its training phase. A model which has only seen or been trained using many examples of the same type of observation will have a difficult time generalizing to different types of observations, while a model which has seen or been trained on several examples of many types of observation will generalize better. Moreover, labeling or annotating a large number of observations of the same type can lead to inefficient use of resources that can be more effectively used to label or annotate a wider range of observations of different types to improve the model generalization.

To address these problems, a system 100 of FIG. 1 introduces a capability to automate the selection of observations for annotation and use in training machine learning models. Given the scale and speed with which observations can be generated with advanced sensors and user behavior logs, annotation effort has become a precious resource to be optimized. For example, in one use case, the system 100 may have at its disposal several hundreds of thousands of street-level vehicle capture images, which the system 100 would like to have annotated with a set of pre-defined features (including lane markings, road signs, and/or poles, among others). However, many of these images or observations are redundant, since, for example, several consecutive images captured along a stretch of highway will contain the same lane markings and road signs, and will have been captured in similar lighting and weather conditions. Expending labeling effort on all of these images is an inefficient use of human resources dedicated to annotation. In addition, as discussed above, machine learning models exhibit increased accuracy and robustness (e.g., improved generalization) when they are trained on diverse sets of observations. By automatically selecting a set of diverse observations for human annotation, the system 100 enables the training of better models with more efficient use of labeling resources. For example, if the system has resources available to annotate 100,000 images or observations, the system can spread those resources to annotating 1,000 observations of 100 different types of features, as opposed to spending the resources to annotate more observations of a less diverse set of feature types if sampling of observations is determined strictly by their naturally occurring prevalence.

Accordingly, in one embodiment, the system 100 automatically selects observations to annotate and/or use as training data for a machine learning model in order to produce a more robust, general output. More specifically, in one embodiment, this is enabled by quantifying the diversity of the training data set and sampling new observations (not yet seen by the model) with respect to two distributions: (1) the distribution of observations within the current training set, and (2) the distribution of observations within the current candidate pool. In one embodiment, the selection of images can be inversely proportional to the product of these distributions, so that selected observations or images are likely to be rare in both the current training set and the current candidate pool. In this manner, the system 100 can ensure that the model is trained on a diverse set of examples, which ensures the resulting predictions will be robust while also optimizing the use of human resources for annotating the observations.

As discussed above, machine learning using, e.g., feature prediction models enable a range of new services and functions including for applications such as autonomous driving. It is noted that although the various embodiments for ensuring the diversity of a machine learning training set are discussed herein with respect to a machine learning system 103 used in conjunction with a computer vision system 105 for autonomous driving applications, it is contemplated that the various embodiments are applicable to any type of machine learning application, service, or function. For example, with respect to autonomous driving, computer vision and computing power have enabled real-time mapping and sensing of a vehicle's environment. Such an understanding of the environment enables autonomous, semi-autonomous, or highly assisted driving in a vehicle (e.g., a vehicle 101) in at least two distinct ways.

First, real-time sensing of the environment provides information about potential obstacles, the behavior of others on the road, and safe, drivable areas. An understanding of where other cars are and what they might do is critical for a vehicle 101 to safely plan a route. Moreover, vehicles 101 generally must avoid both static (lamp posts, e.g.) and dynamic (cats, deer, e.g.) obstacles, and these obstacles may change or appear in real-time. More fundamentally, vehicles 101 can use a semantic understanding of what areas around them are navigable and safe for driving. Even in a situation where the world is completely mapped in high resolution, exceptions will occur in which a vehicle 101 might need to drive off the road to avoid a collision, or where a road's geometry or other map attributes like direction of travel have changed. In this case, detailed mapping may be unavailable, and the vehicle 101 has to navigate using real-time sensing of road features or obstacles using a computer vision system 105 facilitated, for instance, by machine learning processes and models.

A second application of vision techniques in autonomous driving is localization of the vehicle 101 with respect to a map of reference landmarks. Understanding one's location on a map enables planning of a route, both on fine and coarse scales. On a coarse scale, navigation maps allow vehicles 101 to know what roads to use to reach a particular destination. However, on a finer scale, maps allow vehicles 101 to know what lanes to be in and when to make lane changes. Knowing this information is important for planning an efficient and safe route, for in complicated driving situations maneuvers need to be executed in a timely fashion, and sometimes before they are visually obvious. In addition, localization with respect to a map enables the incorporation of other real-time information into route planning. Such information could include traffic, areas with unsafe driving conditions (ice, fog, potholes, e.g.), and temporary road changes like construction.

With respect to lane localization and also generally with respect to autonomous driving, high accuracy and real-time localization of vehicles 101 are needed. Traditionally, most vehicle navigation system have accomplished this localization using GPS, which generally provides a real-time location with a 95% confidence interval of 7.8 meters. However, in complicated urban environments, reflection of GPS signals can further increase this error, such that one's location may be off by as much as 30 meters. Given that the width of many lanes is 3-4 meters, this accuracy is not sufficient to properly localize a vehicle 101 (e.g., an autonomous vehicle) so that it can make safe route planning decisions. Other sensors, such as inertial measurement units (IMUs) can increase the accuracy of localization by taking into account vehicle movement, but these sensors tend to drift and still do not provide sufficient accuracy for localization.

In general, a localization accuracy of around 10 cm is needed for safe driving in many areas. One way to achieve this level of accuracy is to use visual odometry, in which features are detected from imagery using feature prediction models (i.e., a machine learning classifier). These features can then be matched to a database of features to determine one's location. By way of example, traditional feature-based localization that both detect features and localize against them generally rely on low-level features. However, low-level features typically used in these algorithms (e.g., Scale-Invariant Feature Transform (SIFT) or Oriented FAST and rotated BRIEF (ORB)) tend to be brittle and not persist in different environmental and lighting conditions. As a result, they often cannot be used to localize a vehicle on different days in different weather conditions. Aside from reproducibility, the ability to detect and store higher level features of different types (e.g., lane features such as lane markings, lane lines, etc.) can provide better and more accurate localization.

In response to these issues, the system 100 of FIG. 1 (e.g., including the machine learning system 103 and/or computer vision system 105) focuses on detecting high level features that have semantic meaning for human beings. One such feature that is important to autonomous driving is the detection of lane features (e.g., lane markings, lane lines, Botts' dots, reflectors, etc.) and corresponding lane models. Lane-level information is important for self-driving applications because it defines the grammar of driving. Without knowledge of lane markings, it can difficult or impossible to determine where a vehicle 101 should drive, can drive, and what maneuvers are possible. As a result, the ability to detect lane-lines in real-time constitutes a fundamental part for the design of an autonomous vehicle 101.

In other words, the success of localization based on features detected from an image can depend on the precise localization of those features within the image and the quality of the technique used to detect the lane features or other similar features. This success, for instance, can depend greatly on how well trained a feature prediction model is. To create a well-trained machine learning or prediction model, the system 100 can use the embodiments described herein to create a diverse training set of observations.

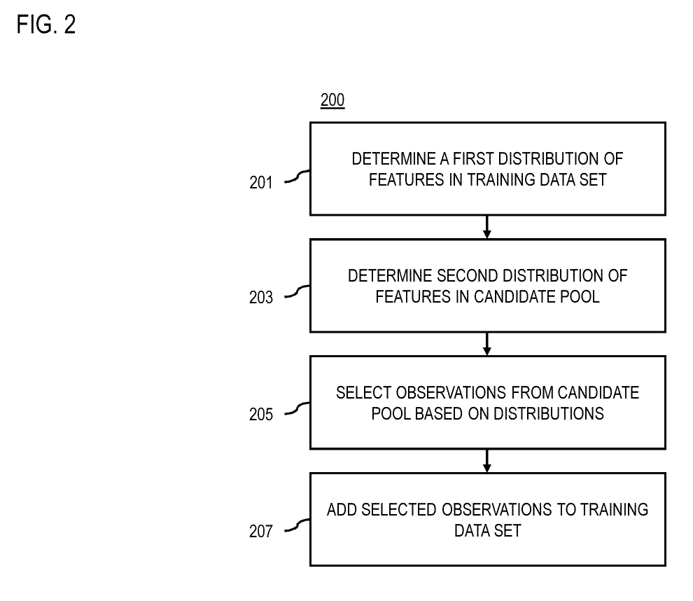

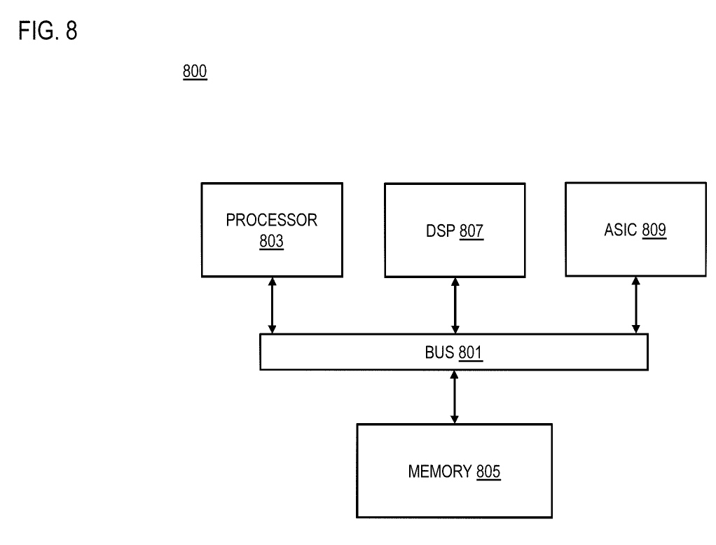

FIG. 2 is a flowchart of a process for selecting training observations for machine learning models, according to one embodiment. In one embodiment, the machine learning system 103 and/or the computer vision system 105 may perform one or more portions of the process 200 and may be implemented in, for instance, a chip set including a processor and a memory as shown in FIG. 8. As such, the machine learning system 103 and/or the computer vision system 105 can provide means for accomplishing various parts of the process 200. In addition or alternatively, a services platform 107 and/or one or more services 109a-109n (also collectively referred to as services 109) may perform any combination of the steps of the process 200 in combination with the machine learning system 103 and/or the computer vision system 105, or as standalone components. Although the process 200 is illustrated and described as a sequence of steps, it is contemplated that various embodiments of the process 200 may be performed in any order or combination and need not include all of the illustrated steps.

In one embodiment, the machine learning system 103 includes or is otherwise associated with a machine learning model which can be used to label data items or observations (e.g., images) with one or more features (e.g., road markings, signs, and/or other objects that are visible in an image and can be used for visual odometry). Generally, a machine learning model (e.g., a set of equations, rules, decision trees, etc.) manipulates an input feature set to make a prediction about the feature set or the phenomenon/observation that the feature set represents. The machine learning system 103 can use any means known in the art to detect features in input observations. As used herein, an observation or data item of the observation can include any data file or data object representing an observed phenomenon from which features can be extracted, and the features can include any property or characteristic of the data item or observed phenomenon.

It is contemplated that the machine learning model and/or the machine learning system 103 can be used to support any service or function. For example, with respect to using the machine learning system 103 for visual odometry for autonomous driving or other image recording use cases, one technique that has shown significant ability to detect lanes or other objects is the use of convolutional neural networks, recurrent neural networks, and/or other equivalent machine learning classifiers to process images. Neural networks have shown unprecedented ability to recognize objects in images, understand the semantic meaning of images, and segment images according to these semantic categories to predict related features. When such neural networks or other machine learning classifiers predict whether an image depicts or is otherwise associated with certain classification features, they can also compute a confidence or probability that the predicted feature is likely to be true. In an embodiment where the features are road or map related, the machine learning system 103 can use the trained machine learning model to generate navigation guidance information.

In one embodiment, as discussed above, the machine learning model uses training or ground truth data to automatically “learn” or detect relationships between different input feature sets and then output a predicted feature. The quality of the feature prediction model and the feature predictions that it makes can be highly dependent on the quality of the training data set used to train the model. Training data is generally created by human labelers who manually mark labels for each data item in the training data set. For example, with respect to a use case of machine learning based object detection in images, the training or ground data truth data can include a set of images that have been manually marked or annotated with feature labels to indicate examples of the features or objects of interest. A manually marked feature that is an object (e.g., lane markings, road signs, etc.), for instance, can be a polygon or polyline representation of the feature that a human labeler has visually detected in the image. In one embodiment, the polygon, polyline, and/or other feature indicator can outline or indicate the pixels or areas of the image that the labeler designates as depicting the labeled feature. As discussed above, the training data set can potentially require thousands of examples (e.g., individual data item or images) marked with each feature of interest to train the feature prediction model to a specified quality.

In one embodiment, diversity of the types of observations included in the training can further increase the accuracy and robustness of the model. To provide for this robustness, the machine learning system 103 can start by quantifying the diversity of the current or initial training data set as well as a candidate pool of observations (e.g., a pool containing observations that have not been previously seen or used to train the machine learning model) from which the machine learning system 103 can select for annotation and/or inclusion in the training data set. Accordingly, in step 201, the machine learning system 103 determines a first distribution of a plurality of features observed in the training data set. In one embodiment, the plurality of features includes an individual observation of the training data set, metadata describing the training observations, characteristics derived from the observations, or a combination thereof. The metadata describing the training observations, for instance, can include a geographic location where a respective one of the training observations was collected.

In other words, to quantify the distribution of observations, the machine learning system 103 can determine use-case-specific features which describe the observations in categorical or numerical terms. Depending on the use-case, these features could be the observations themselves; features derived from the raw observations; metadata describing the circumstances of the collection of the observations; or any combination of the preceding. For example, in an autonomous driving or navigation use-case, the machine learning system 103 can use features derived from street-level capture imagery (including the output of a semantic segmentation engine as well as exposure and hue), the geographic location of the capture (a latitude/longitude pair), and/or other map features (e.g., features stored in the geographic database 111) associated with the geographic location of the capture. For example, the other map features can include, but are not limited, to a functional class, a speed category, etc. of the road link where the capture was taken. In this case, the machine learning system 103 can interact with the geographic database 111 to map-match the geographic coordinates (e.g., latitude/longitude) of the capture to associate it with a map data record (e.g., road link, map tile, point of interest, etc.) and its associated features (e.g., functional class, speed category, etc.).

In one embodiment, given the use-case specific features, the machine learning system 103 can determine a feature distribution by constructing, for instance, a one-class probability model that attempts to separate the “bulk” of the observations from outliers. One example of such a probability model includes, but is not limited, to a One-Class Support Vector Machine of Scholkopf et al. It is noted that the embodiments described herein are not limited to any particular form of probability model, and that any probability known in the art can be used. In one embodiment, the machine learning system 103 fits two such probability models: one to the current training set (e.g., downsampling uniformly at random as necessitated by computational resource limitations), thereby determining a first distribution of features observed in the training data set (step 201); and another to the current candidate pool (e.g., downsampling uniformly at random as necessitated by computational resource limitations), thereby creating a second distribution of features observed in the candidate pool of observations (step 203).

In step 205, the machine learning system 103 selects one or more observations in the candidate pool of observations for annotation based on the first distribution and the second distribution. In one embodiment, with these two distribution models, respectively p train (i.e., the distribution model for the training data set) and p pool (i.e., the distribution model of for the candidate pool of observations), the machine learning system 103 can define an importance sampling scheme as follows:

P(observation X is selected from candidate pool)=C/(p_train(X)*p_pool(X))

where the normalization constant C is chosen to ensure P is a probability distribution, and P(observation X is selected from candidate pool) is the probability that a given observation X is selected from the candidate pool of observations. Note that in this embodiment, the probability that an observation is selected is inversely proportional to its similarity (e.g., based on its features) to both the current training set and the current pool of candidate observation. This ensures that selected observations are biased towards rare classes or types of observations in both sets, which in turn increases the diversity of observations in the training set. When resources available for annotating the observations are constrained, the selection also ensures that the use of the resources are advantageously optimized to create a diverse training data set. It is noted that the sampling scheme described in the function above is provided by way of illustration and is not intended as a limitation. In one embodiment, the machine learning system 103 can use any function to determine the sampling probability of a given observation based on the feature distributions of the training data set and the candidate pool of observations. Examples of alternate non-increasing functions that can be used according to the embodiments described herein include, for instance, f(x)=1/(1+x̂2), f(x)=exp(−x̂2), etc.

Thus, in one embodiment, the machine learning system 103 uses a simultaneous criterion that the selected observations be both rare with respect to the training data set and the candidate pool. This simultaneous criterion is supported, for instance, by the following rationale. Suppose that the current training set was composed of two classes, A and B (e.g., each class representing a feature), with 50 observations of each class. Suppose further than the candidate pool contained 10 observations of class A and 90 observations of class B, and that the machine learning system 103 is to select 10 observations from the candidate pool to be labeled and added to the training set. Since the training set is already balanced between the classes, the optimal choice to maintain this maximum diversity would be to select 5 observations of each class from the candidate pool. However, if the sampling probability were inversely proportional to the frequency of occurrence in the training set only (e.g., a frequency of 1/2 for each class A and B), the machine learning system 103 would select each image in the candidate pool with equal probability. Since the classes are imbalanced in the candidate pool, on average this would result in selecting 9 observations of class B and only 1 of class A:

E(A)=10*C/(1/2)=20C

E(B)=90*C/(1/2)=180C

where the normalization constant C is chosen to ensure P is a probability distribution, E(A) is the expected number of observations belonging to class A selected from the candidate pool of observations, and E(B) is the expected number of observations belonging to class B selected from the candidate pool of observations.

However, in an embodiment in which the machine learning system 103 specifies that the sampling probability is inversely proportional to the frequency of occurrence in the candidate pool (e.g., a frequency of 1/10 for class A, and a frequency of 9/10 for class B) in addition to the frequency of occurrence in the training data set (e.g., a frequency of 1/2 for each class A and B), the imbalance will be corrected, and on average the machine learning system 103 will select 5 observations of each class:

E(A)=10*C/(1/2*1/10)=200C

E(B)=90*C/(1/2*9/10)=200C

where the normalization constant C is chosen to ensure P is a probability distribution, E(A) is the expected number of observations belonging to class A selected from the candidate pool of observations, and E(B) is the expected number of observations belonging to class A selected from the candidate pool of observations.

In other words, the sampling probability of the one or more selected observations is based on a similarity of the one or more observations to other observations in the training data set and the candidate pool of observations (e.g., depending on which distribution is being determined). The machine learning system 103 can determine the sampling probability for the one or more observations based on a product of the first distribution and the second distribution (e.g., based on being inversely proportional to the product). The one or more observations are selected from the candidate pool of observations based on the sampling probability.

In one embodiment, to determine the distributions described above, the machine learning system 103 fits a One Class Support Vector Machine (SVM) or equivalent probability model to a set of observations. This model provides a score for each observation indicating whether or not a particular observation lies within the bulk of the observations in a high-dimensional kernel feature space. The sign of this score (e.g., positive or negative) indicates which side of the classification boundary the observation lies on (e.g., negative for outliers, positive for inliers), while the value of this score indicates the distance (in kernel feature space) from the classification boundary. This distance is not an indication of similarity itself, that is, it is not the case that large positive values are more “typical” than small positive values. However, the machine learning system 103 can use the distribution of these values over the training set or candidate pool to fit a one-dimensional probability model using, for example, a Kernel Density Estimate (KDE) or other equivalent process to estimate the probability density function of a random variable. A KDE, for instance, can be considered as a histogram of distribution of the distance values over the feature space discussed above. It is noted that the particular form of the probability model or of the KDE described herein is provided by way of illustration and is not intended as a limitation, and therefore any equivalent model or estimator can be used according to various embodiments described herein.

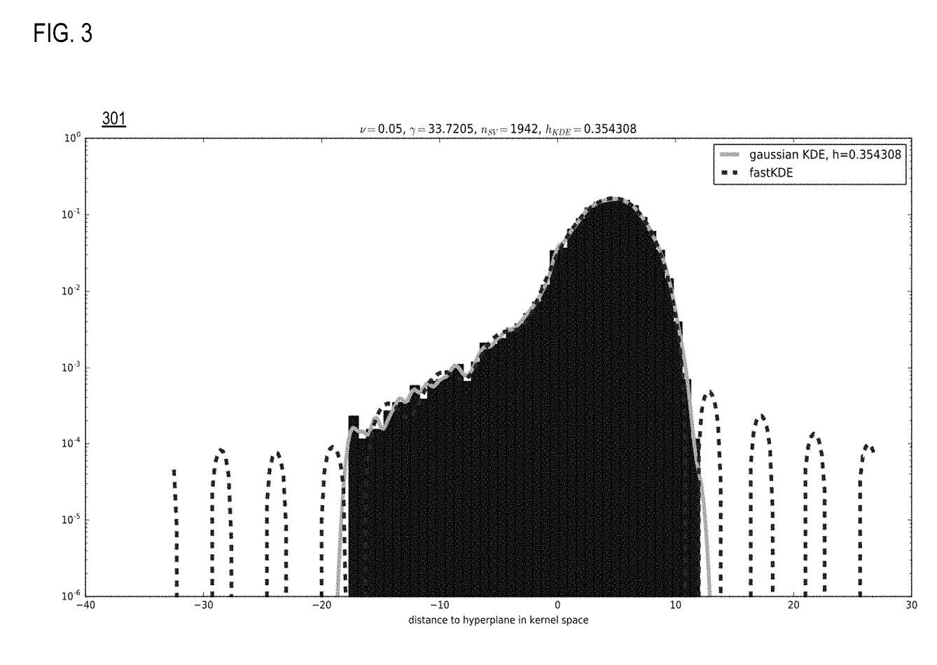

FIG. 3 is an example distribution in kernel feature space used for selecting training observations, according to one embodiment. More specifically, the distribution 301 depicts a distribution of distances from the decision boundary of a one-class SVM with a fitted KDE. In this example, the KDE is fitted using, for instance, a Python gaussian KDE function indicated by the solid lighter shaded line along the contour of the distribution, as well as using a Python fastKDE function as indicated by the dashed darker shaded line along the contour of the distribution.

In step 207, the machine learning system 103 adds the one or more observations to the training data set after annotation for training of the machine learning model after annotation. As discussed above, most methods for developing feature detection systems are dependent on training data sets containing manually-annotated data libraries. These libraries consist of thousands of examples of a given feature. Each example generally relies on a human user (e.g., a labeler) to identify, label, and/or categorize features of interest. In addition, to provide a well-trained feature prediction model or classifier, the corresponding training data libraries often must contain a high volume of accurate feature examples that is diverse with respect to use-case specific features. At the same time, resources dedicated to manual annotation typically is limited. By automatically selecting diverse candidate observations for annotation, the machine learning system 103 can optimize the limited available resources to ensure the creation of a diverse training data set.

Therefore, in one embodiment, each selected observation is flagged and/or presented for annotation (e.g., via a user interface of a device used for manual annotation). In some cases, human users or labelers who are asked to annotate complex observations at high speed for extended periods of time can make errors which can corrupt portions of the training data library. Corrupted or inaccurate feature examples negatively impact on the precision and recall of a feature detection system. Accordingly, in some embodiments, the machine learning system 103 can use manual and/or automated quality assurance (QA) to reduce error rates in training data libraries. After the observation is annotated and QA'ed (if QA procedures are in place), the machine learning system 103 adds or stores the newly annotated observation in the training data set.

In one embodiment, the machine learning system 103 can then train or re-train the machine learning model using the updated training data set. For example, the machine learning system 103 can incorporate a supervised learning model (e.g., a logistic regression model, RandomForest model, and/or any equivalent model) to provide feature matching probabilities that are learned from the training data set. For example, during training, the machine learning system 103 uses a learner module that feeds feature sets from the training data set into the machine learning model to compute a predicted matching feature using an initial set of model parameters. The learner module then compares the predicted matching probability and the predicted feature to the ground truth data (e.g., the manually annotated feature labels) in the training data set for each observation (e.g., image) used for training. The learner module then computes an accuracy of the predictions for the initial set of model parameters. If the accuracy or level of performance does not meet a threshold or configured level, the learner module incrementally adjusts the model parameters until the model generates predictions at a desired or configured level of accuracy with respect to the manually annotated labels in the training data (e.g., the ground truth data). In other words, a “trained” feature prediction model is a classifier with model parameters adjusted to make accurate predictions with respect to the training data set.

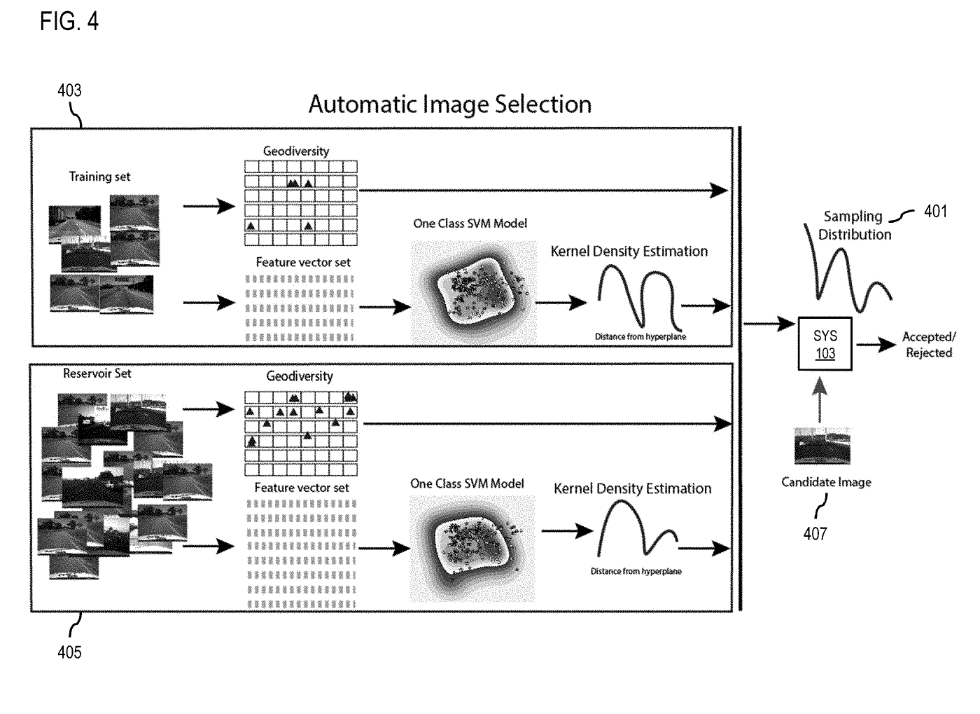

In one embodiment, depending on the use case, the machine learning system 103 can incorporate features descriptive of the observation content as well as the circumstances of the observation collection. For example, the geographic location of the observation can relevant in some use cases (e.g., navigation, localization, autonomous driving, mapping, and/or the like). FIG. 4 is a diagram illustrating an architecture for implementing the diversity sampling scheme to automatically select images for training a machine learning model to recognize visual features (e.g., road features, lane markings, road signs, poles, roadside objects, etc.) in images. In this example, the machine learning system 103 constructs a sampling distribution 401 with respect to geographic location (e.g., geodiversity) as well as observation content (e.g., a feature vector set) for both the training data set 403 and the candidate pool or reservoir set 405. The machine learning system 103 generates respective distributions or probability models for the training set 401 and the reservoir set 405 according to the various embodiments described herein. These distributions are combined into a single model (e.g., the sampling distribution 401) describing a candidate observation 407's similarity to the training set and/or the candidate pool at evaluation time to either accept or reject the candidate observation 407 from the reservoir set 405 for annotation and inclusion in the training data set 403.

In one embodiment, the embodiments of the sampling procedure described herein can be implemented in several ways including, but not limited to: (1) a one-time batch process to either select an initial group of observations to form a candidate set or to augment a pre-defined training set; (2) a regular batch process to select observations at a fixed collection frequency (e.g. once per day, week, or month); (3) a streaming process in which observations are evaluated as they are acquired, and the corresponding probability models are accordingly updated. For example, one example observation processing scheme can implement a pipeline of type (2) in which the machine learning system 102 fixes a current training set and adds a fixed number of observations according to the embodiments of the sampling distribution described above. In one embodiment, the machine learning can iterate the sampling procedure through any number of rounds to update the two probability models (e.g., models for the training data set and candidate pool) and accordingly the sampling distribution over the candidate pool of observations.

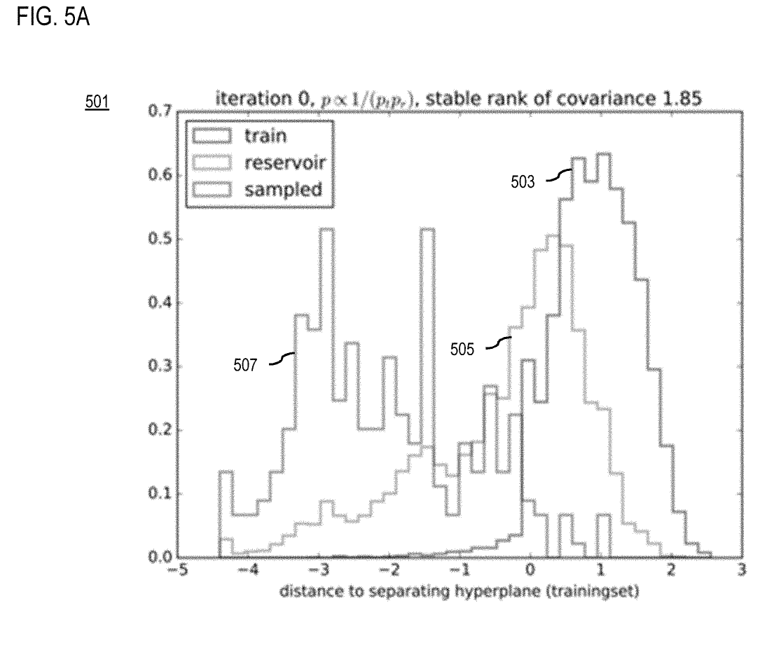

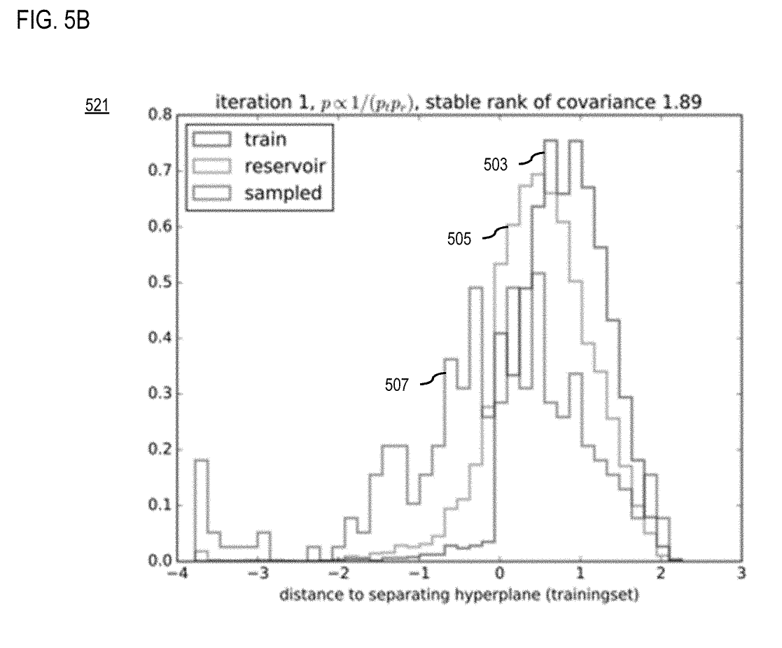

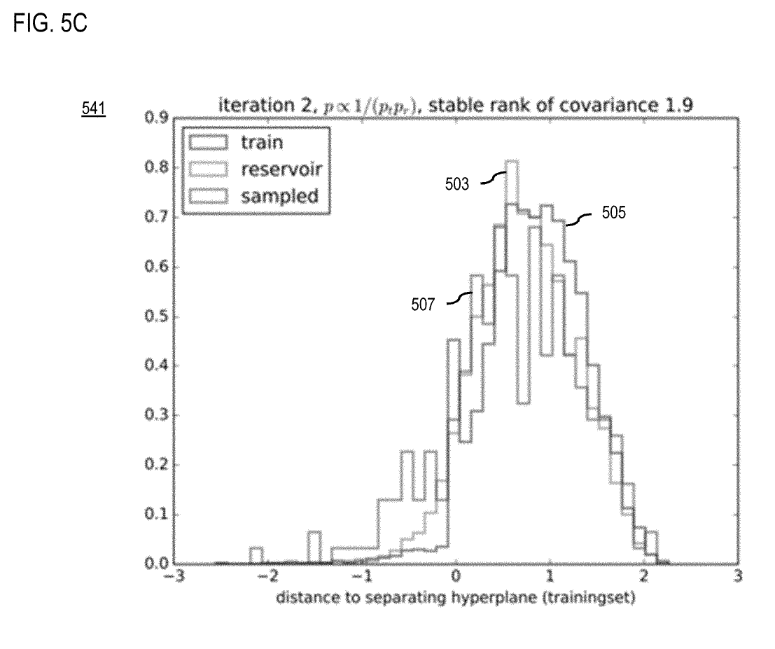

FIGS. 5A-5C are diagrams illustrating the distributions of training, candidate, and sampled observations through iterations of the observation selection procedure, according to various embodiments. More specifically, FIGS. 5A-5C show the distributions of the training set, candidate pool (labeled “reservoir”), and the sampled observations for three respective iterations of this procedure. In the first iteration 501 of FIG. 5A, the distribution of the training set 503 and the distribution of the candidate set 505 are qualitatively different, with much of the mass of the candidate pool 505 residing in low-probability regions of the training distribution. The sampled observations 507 are disproportionally selected from these regions (negative x-axis values in FIG. 5A) and are added to the training set. In the second iteration 521 of FIG. 5B, the distribution of training set 503 and the distribution of the candidate set 505 are more similar, owing to the addition of the selected observations 507. However, there are still candidate images with low similarity to the training set, and they are again selected disproportionately. In the third iteration 541 of FIG. 5C, three distributions 503-507 appear qualitatively similar, indicating that the diversity sampling procedure has injected sufficient diversity into the training set to reflect the diversity of the candidate pool of observations. Accordingly, in one embodiment, the machine learning system 103 can iteratively perform the embodiments of the sampling procedure described herein until the distributions of the training set, the candidate pool, and the sample observations meet a similarity metric to within threshold criteria.

Returning to FIG. 1, as shown, the system 100 includes the machine learning system 103 for providing diverse training data to train a feature prediction model according the various embodiments described herein. In some use cases, the system 100 can include the computer vision system 105 configured to use machine learning to detect objects or features depicted in images. For example, with respect to autonomous, navigation, mapping, and/or other similar applications, the computer vision system 105 can detect road features (e.g., lane lines, signs, etc.) in an input image and generate associated prediction confidence values, according to the various embodiments described herein. In one embodiment, the machine learning system 103 includes a neural network or other machine learning/parallel processing system to make predictions from machine learning models. For example, when the observations are images used for visual odometry, the features of interest can include lane lines in image data to support localization of, e.g., a vehicle 101 within the sensed environment. In one embodiment, the neural network of the machine learning system 103 is a traditional convolutional neural network which consists of multiple layers of collections of one or more neurons (e.g., processing nodes of the neural network) which are configured to process a portion of an input image. In one embodiment, the receptive fields of these collections of neurons (e.g., a receptive layer) can be configured to correspond to the area of an input image delineated by a respective a grid cell generated as described above.

In one embodiment, the machine learning system 103 and/or the computer vision system 105 also have connectivity or access to a geographic database 111 which stores representations of mapped geographic features to facilitate visual odometry to increase localization accuracy. The geographic database 111 can also store parametric representations of lane lines and other similar features and/or related data generated or used to encode or decode parametric representations of lane lines according to the various embodiments described herein.

In one embodiment, the machine learning system 103 and/or computer vision system 105 have connectivity over a communication network 113 to the services platform 107 that provides one or more services 109. By way of example, the services 109 may be third party services and include mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 109 uses the output of the machine learning system 103 and/or of the computer vision system 105 (e.g., detected lane features) to localize the vehicle 101 or a user equipment 115 (e.g., a portable navigation device, smartphone, portable computer, tablet, etc.) to provide services 109 such as navigation, mapping, other location-based services, etc.

In one embodiment, the machine learning system 103 and/or computer vision system 105 may be a platform with multiple interconnected components. The machine learning system 103 and/or computer vision system 105 may include multiple servers, intelligent networking devices, computing devices, components and corresponding software for providing parametric representations of lane lines. In addition, it is noted that the machine learning system 103 and/or computer vision system 105 may be a separate entity of the system 100, a part of the one or more services 109, a part of the services platform 107, or included within the UE 115 and/or vehicle 101.

In one embodiment, content providers 117a-117m (collectively referred to as content providers 117) may provide content or data (e.g., including geographic data, parametric representations of mapped features, etc.) to the geographic database 111, the machine learning system 103, the computer vision system 105, the services platform 107, the services 109, the UE 115, the vehicle 101, and/or an application 119 executing on the UE 115. The content provided may be any type of content, such as map content, textual content, audio content, video content, image content, etc. In one embodiment, the content providers 117 may provide content that may aid in the detecting and classifying of lane lines and/or other features in image data, and estimating the quality of the detected features. In one embodiment, the content providers 117 may also store content associated with the geographic database 111, machine learning system 103, computer vision system 105, services platform 107, services 109, UE 115, and/or vehicle 101. In another embodiment, the content providers 117 may manage access to a central repository of data, and offer a consistent, standard interface to data, such as a repository of the geographic database 111.

In one embodiment, the UE 115 and/or vehicle 101 may execute a software application 119 to collect, encode, and/or decode feature data detected in image data to select training observations for machine learning models according the embodiments described herein. By way of example, the application 119 may also be any type of application that is executable on the UE 115 and/or vehicle 101, such as autonomous driving applications, mapping applications, location-based service applications, navigation applications, content provisioning services, camera/imaging application, media player applications, social networking applications, calendar applications, and the like. In one embodiment, the application 119 may act as a client for the machine learning system 103 and/or computer vision system 105 and perform one or more functions associated with selecting training observations for machine learning models alone or in combination with the machine learning system 103.

By way of example, the UE 115 is any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 115 can support any type of interface to the user (such as “wearable” circuitry, etc.). In one embodiment, the UE 115 may be associated with the vehicle 101 or be a component part of the vehicle 101.

In one embodiment, the UE 115 and/or vehicle 101 are configured with various sensors for generating or collecting environmental image data (e.g., for processing by the machine learning system 103 and/or computer vision system 105), related geographic data, etc. In one embodiment, the sensed data represent sensor data associated with a geographic location or coordinates at which the sensor data was collected. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the UE 115 and/or vehicle 101 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the UE 115 and/or vehicle 101 may detect the relative distance of the vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the UE 115 and/or vehicle 101 may include GPS or other satellite-based receivers to obtain geographic coordinates from satellites 121 for determining current location and time. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In one embodiment, the communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the machine learning system 103, computer vision system 105, services platform 107, services 109, UE 115, vehicle 101, and/or content providers 117 communicate with each other and other components of the system 100 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

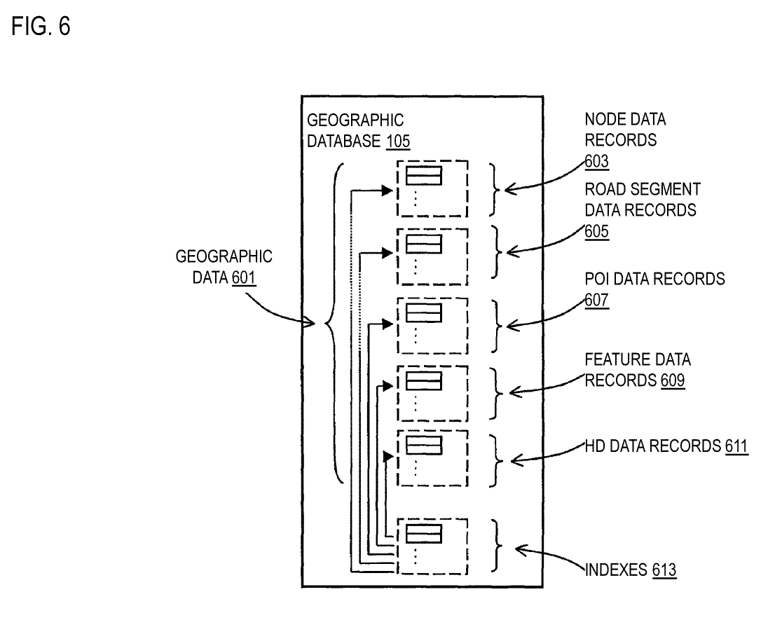

FIG. 6 is a diagram of a geographic database, according to one embodiment. In one embodiment, the geographic database 111 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 111 include high resolution or high definition (HD) mapping data that provide centimeter-level or better accuracy of map features. For example, the geographic database 111 can be based on Light Detection and Ranging (LiDAR) or equivalent technology to collect billions of 3D points and model road surfaces and other map features down to the number lanes and their widths. In one embodiment, the HD mapping data (e.g., HD data records 611) capture and store details such as the slope and curvature of the road, lane markings, roadside objects such as sign posts, including what the signage denotes. By way of example, the HD mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 111.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 111 follows certain conventions. For example, links do not cross themselves and do not cross each other except at a node. Also, there are no duplicated shape points, nodes, or links. Two links that connect each other have a common node. In the geographic database 111, overlapping geographic features are represented by overlapping polygons. When polygons overlap, the boundary of one polygon crosses the boundary of the other polygon. In the geographic database 111, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 111 includes node data records 603, road segment or link data records 605, POI data records 607, machine learning data records 609, HD mapping data records 611, and indexes 613, for example. More, fewer or different data records can be provided. In one embodiment, additional data records (not shown) can include cartographic (“carto”) data records, routing data, and maneuver data. In one embodiment, the indexes 613 may improve the speed of data retrieval operations in the geographic database 111. In one embodiment, the indexes 613 may be used to quickly locate data without having to search every row in the geographic database 111 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points corresponding to the respective links or segments of the road segment data records 605. The road link data records 605 and the node data records 603 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 607. The geographic database 111 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

In one embodiment, the geographic database 111 can also include machine learning data records 609 for storing training data, prediction models, annotated observations, computed featured distributions, sampling probabilities, and/or any other data generated or used by the system 100 according to the various embodiments described herein. By way of example, the machine learning data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the HD mapping data records 611 model road surfaces and other map features to centimeter-level or better accuracy. The HD mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 611 are divided into spatial partitions of varying sizes to provide HD mapping data to vehicles 101 and other end user devices with near real-time speed without overloading the available resources of the vehicles 101 and/or devices (e.g., computational, memory, bandwidth, etc. resources).

In one embodiment, the HD mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 611.

In one embodiment, the HD mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 111 can be maintained by the content provider 117 in association with the services platform 107 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle (e.g., vehicle 101 and/or UE 115) along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or UE 115, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for selecting training observations for machine learning models may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

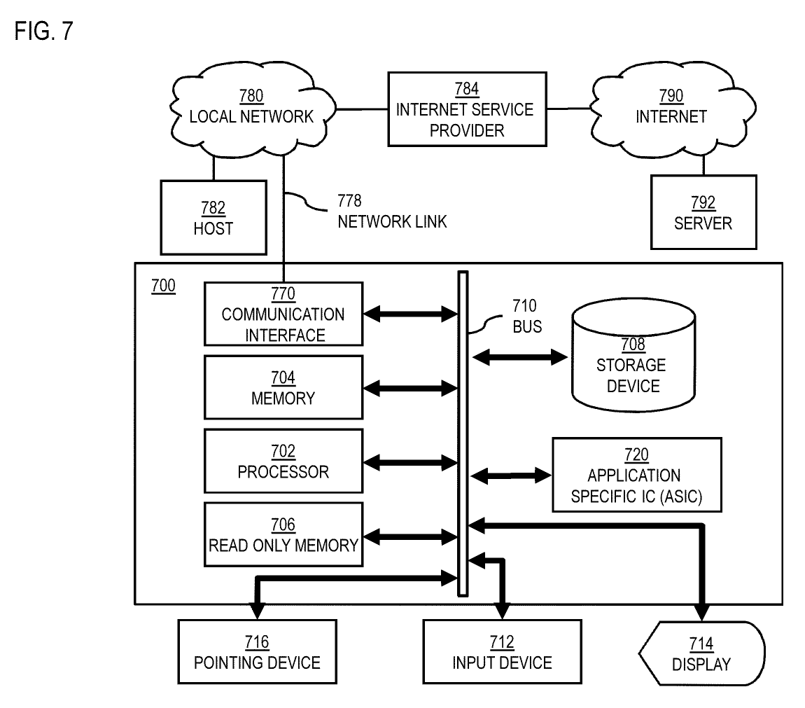

FIG. 7 illustrates a computer system 700 upon which an embodiment of the invention may be implemented. Computer system 700 is programmed (e.g., via computer program code or instructions) to select training observations for machine learning models as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to selecting training observations for machine learning models. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for selecting training observations for machine learning models. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for selecting training observations for machine learning models, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 113 for selecting training observations for machine learning models.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 8 illustrates a chip set 800 upon which an embodiment of the invention may be implemented. Chip set 800 is programmed to select training observations for machine learning models as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to select training observations for machine learning models. The memory 805 also stores the data associated with or generated by the execution of the inventive steps.

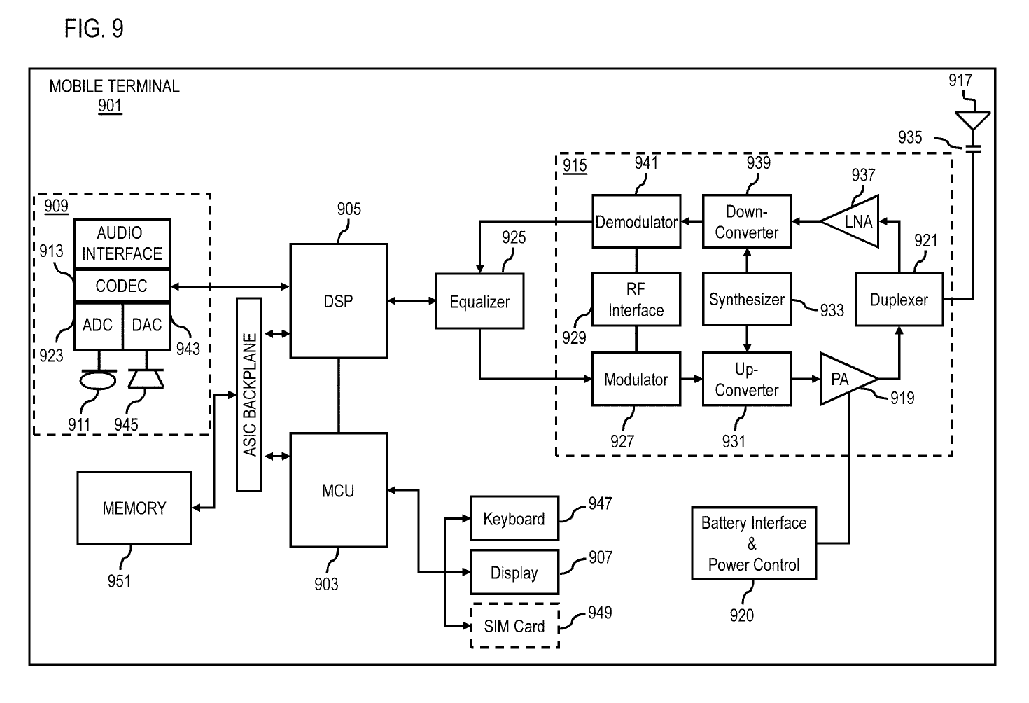

FIG. 9 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to select training observations for machine learning models. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method for sampling from a candidate pool of observations to create a training data set for a machine learning model comprising:
determining, by a processor, a first distribution of a plurality of features observed in the training data set;
determining a second distribution of the plurality of features observed in the candidate pool of observations;
selecting one or more observations in the candidate pool of observations for annotation based on the first distribution and the second distribution; and
adding the one or more observations to the training data set after annotation,
wherein the training data set is used for training the machine learning model.

2. The method of claim 1, wherein a sampling probability of the one or more selected observations is based on a similarity of the one or more observations to other observations in the training data set and the candidate pool of observations.

3. The method of claim 1, further comprising:
determining a sampling probability for the one or more observations based on a product of the first distribution and the second distribution,
wherein the one or more observations are selected from the candidate pool of observations based on the sampling probability.

4. The method of claim 1, wherein the plurality of features includes an individual observation of the training data set, metadata describing the training observations, characteristics derived from the observations, or a combination thereof.

5. The method of claim 4, wherein the metadata describing the training observations include a geographic location where a respective one of the training observations was collected, map features associated with the geographic location, or a combination thereof.

6. The method of claim 1, further comprising:
creating a feature space for each observation of the candidate pool of observations based on the plurality of features associated with said each observation; and
calculating a score for said each observation based on the plurality of features,
wherein the one or more observations are selected based on the score for said each observation.

7. The method of claim 6, further comprising:
determining a distribution of the score for said each observation,
wherein the one or more observations are further based on the distribution.

8. The method of claim 6, wherein the score indicates whether said each observation is an outlier or an inlier with respect to the feature space.

9. The method of claim 1, wherein the one or more observations are selected to be added to the training data (a) when the training data set and the candidate pool of observations are first created, (b) at a fixed frequency, (c) as the candidate pool of observations is collected, or (d) a combination thereof.

10. The method of claim 1, further comprising:
iteratively determining the first distribution and the second distribution as the one or more observations are selected to be added to the training data set.

11. An apparatus for sampling from a candidate pool of observations to create a training data set for a machine learning model comprising:
at least one processor; and
at least one memory including computer program code for one or more programs,
the at least one memory and the computer program code configured to, with the at least one processor, cause the apparatus to perform at least the following,
determine a first distribution of a plurality of features observed in the training data set;
determine a second distribution of the plurality of features observed in the candidate pool of observations;
select one or more observations in the candidate pool of observations for annotation based on the first distribution and the second distribution; and
add the one or more selected observations to the training data set after annotation,
wherein the training data set is used for training the machine learning model.

12. The apparatus of claim 11, wherein a sampling probability of the one or more selected observations is based on a similarity of the one or more observations to other observations in the training data set and the candidate pool of observations.

13. The apparatus of claim 11, wherein the apparatus is further caused to:
determine a sampling probability for the one or more observations based on a product of the first distribution and the second distribution,
wherein the one or more observations are selected from the candidate pool of observations based on the sampling probability.

14. The apparatus of claim 11, wherein the plurality of features includes an individual observation of the training data set, metadata describing the training observations, characteristics derived from the observations, or a combination thereof.

15. The apparatus of claim 14, wherein the metadata describing the training observations include a geographic location where a respective one of the training observations was collected, map features associated with the geographic location, or a combination thereof.

16. A non-transitory computer-readable storage medium for sampling from a candidate pool of observations to create a training data set for a machine learning model, carrying one or more sequences of one or more instructions which, when executed by one or more processors, cause an apparatus to perform:
determining, by a processor, a first distribution of a plurality of features observed in the training data set;
determining a second distribution of the plurality of features observed in the candidate pool of observations;
selecting one or more observations in the candidate pool of observations for annotation based on the first distribution and the second distribution; and
adding the one or more selected observations to the training data set after annotation,
wherein the training data set is used for training the machine learning model.

17. The non-transitory computer-readable storage medium of claim 16, wherein the apparatus further is caused to perform:
creating a feature space for each observation of the candidate pool of observations based on the plurality of features associated with said each observation; and
calculating a score for said each observation based on the plurality of features,
wherein the one or more observations are selected based on the score for said each observation.

18. The non-transitory computer-readable storage medium of claim 17, wherein the apparatus further is caused to perform:
determining a distribution of the score for said each observation,
wherein the one or more observations are further based on the distribution.

19. The non-transitory computer-readable storage medium of claim 17, wherein the score indicates whether said each observation is an outlier or an inlier with respect to the feature space.

20. The non-transitory computer-readable storage medium of claim 17, further comprising:
iteratively determining the first distribution and the second distribution as the one or more observations are selected to be added to the training data set.
